(19) United States
(12) Patent Application Publication
(10) Pub. No.: US 2005/0000622 A1
(43) Pub. Date: Jan. 6, 2005

(54) Method of producing garment blanks having seamless trim

(76) Inventor: Carlos Alberto Cano, Estado De Mexico (MX)

Correspondence Address: CHARLES N. J. RUGGIERO, ESQ.;OHLANDT, GREELEY, RUGGIERO & PERLE, L.L.P., 10th FLOOR, ONE LANDMARK SQUARE, STAMFORD, CT, 06901-2682, US

(21) Appl. No.: 10/835,242

(22) Filed: Apr. 29, 2004

Related U.S. Application Data
(63) Continuation-in-part of application No. 10/452,779, filed on May 30, 2003.

(51) Int. Cl. B32B 31/20

(52) U.S. Cl. 156/93; 156/155; 156/308.4

(57) ABSTRACT

A method of forming a garment blank having a seamless trim is provided. The method includes applying an adhesive layer in a selected position on the garment blank; applying a fabric layer to the adhesive layer; securing the adhesive and fabric layers in the selected position with a seam; and exposing the garment blank to at least one condition sufficient to cause the adhesive layer to bond the fabric layer to the garment blank and the seam to dissipate.

### CROSS REFERENCE TO RELATED APPLICATIONS

This application is a continuation-in-part application of U.S. application Ser. No. 10/452,779 filed May 30, 2003, the contents of which are incorporated by reference herein.

### BACKGROUND OF THE INVENTION

1. Field of the Invention

The present invention relates to methods of producing garment blanks. More particularly, the present invention relates to methods of producing garment blanks having a seamless trim.

2. Description of Related Art

Intimate apparel garments are worn directly next to the skin. Thus, it can provide particular challenges with respect to maximizing the user's comfort while wearing the garment. Many intimate apparel garments include a trim or edging (hereinafter “trim”) at the periphery of the garment. The trim provides one or more benefits to the garment. For example, the trim can mitigate unraveling of the garment at the periphery. Further, the trim can be used to provide elastic properties to the garment. Further, the trim can provide a decorative or aesthetically pleasing appearance to the garment.

The trim can be a separate piece that is secured to a garment blank during manufacture of the desired garment. Alternately, the trim can be a portion of the garment blank that has been folded over an elastic band and the secured again to the main portion of the blank. The trim has commonly been secured to the garment blank by a line of stitching or a seam. However, this seam defines an area of discontinuity in the resultant garment, which can be aesthetically and/or physically displeasing.

Accordingly, there is a desire for garments that have the benefits available from prior trims, but without one or more of the aforementioned drawbacks and deficiencies of the prior trims.

### BRIEF SUMMARY OF THE INVENTION

It is an object of the present invention to provide methods of providing a garment blank with a seamless trim.

It is another object to provide methods of forming a garment blank having a seamless elastic trim.

It is another object to provide reliable methods of forming garment blanks having a seamless trim.

These and other objects and advantages of the present invention are provided by a method of forming a garment blank having a seamless trim. The method includes applying an adhesive layer in a selected position on the garment blank; applying a fabric layer to the adhesive layer; securing the adhesive and fabric layers in the selected position with a seam; and exposing the garment blank to at least one condition sufficient to cause the adhesive layer to bond the fabric layer to the garment blank and the seam to dissipate.

The present invention also provides a method of forming a garment blank having a seamless trim where the method includes applying a laminated member to the garment blank so that an adhesive layer of the laminated member contacts the garment blank and a fabric layer of the laminated member has a selected position with respect to the garment blank; maintaining the laminated member in the selected position with a seam; activating the adhesive layer with a first level of heat to secure the fabric layer in the selected position; and applying a second level of heat to the laminated member to cause the seam to dissipate.

The present invention further provides a method of forming a garment blank having a seamless trim where the method includes applying an adhesive layer of a laminated member to a first side of the garment blank at a peripheral edge of the garment blank; sewing the laminated member to the garment blank with at least one seam; activating the adhesive layer to secure a fabric layer of the laminated member to the garment blank; and dissipating the at least one seam.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1 is a perspective view of an exemplary embodiment of a garment blank for use with the methods of the present invention;

FIG. 2 is a partial sectional view of the peripheral edge of the garment blank of FIG. 1;

FIGS. 3 through 6 illustrate an exemplary embodiment of a method for providing a seamless trim to the garment blank of FIG. 2; and

FIGS. 7 through 9 illustrate a second exemplary embodiment of a method for providing a seamless trim to the garment blank of FIG. 2.

### DETAILED DESCRIPTION OF THE INVENTION

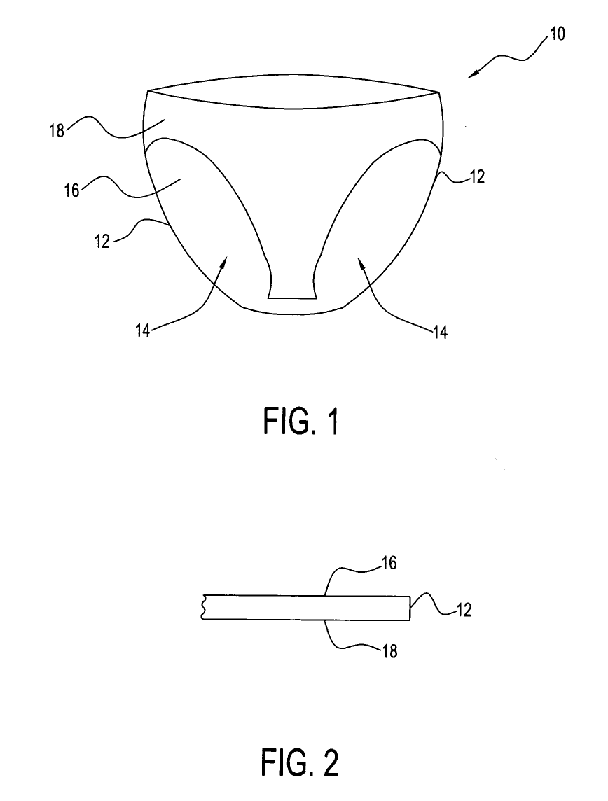

Referring to the drawings and in particular to FIGS. 1 and 2, an exemplary embodiment of a garment blank generally represented by reference numeral 10 is illustrated. Blank 10 has one or more peripheral edges 12 defined therein.

For purposes of clarity, blank 10 is illustrated for use as an intimate apparel garment, particularly, a panty where peripheral edges 12 define, for example, a set of leg holes 14. Of course, it is contemplated by the present invention for blank 10 to find use with other garments such as, but not limited to, a brassiere, a pair of underwear, and other such intimate apparel garments.

Blank 10 has a first side 16 and a second side 18. In the exemplary embodiment, first side 16 faces the skin of the wearer, while second side 18 faces away from the wearer. Of course, it is contemplated by the present invention for first side 16 to face away from the wearer and second side 18 to face the skin of the wearer.

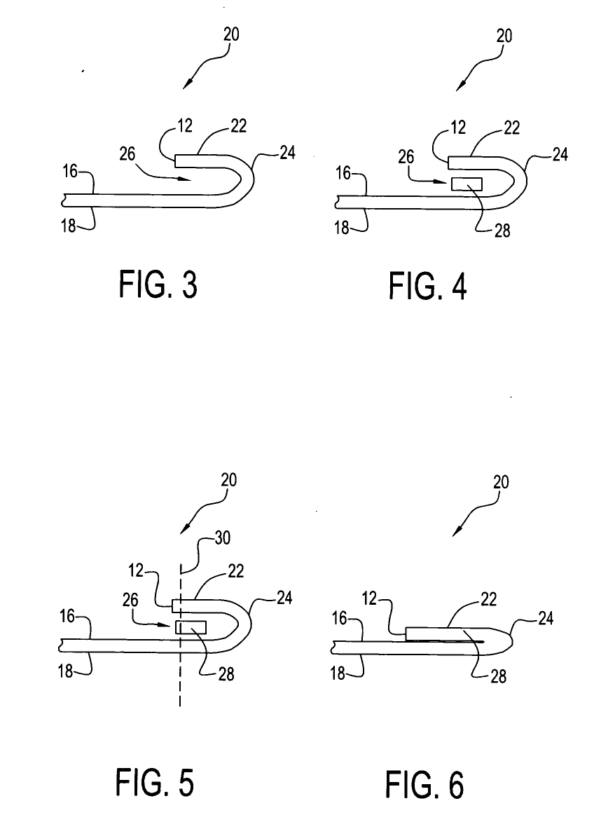

An exemplary embodiment of a method 20 according to the present invention for providing blank 10 with a seamless trim 22 is illustrated with simultaneous reference to FIGS. 3 through 6. In this embodiment, trim 22 is a portion of blank 10 that has been folded over and secured to the blank. Thus, the fold of trim 22 moves peripheral edge 12 internal to blank 10, shown in FIG. 1, and provides a curved edge 24 to blank 10.

During method 20, peripheral edge 12 is folded toward first side 16 to form curved edge 24 facing outward of blank 10 and a cavity 26 facing inward of the blank. Before or simultaneous to the formation of cavity 26, method 20 applies an adhesive binding 28 to blank 10. For example, binding 28 can be applied to first side 16 in the cavity after blank 10 has been folded. Alternately, binding 28 can be inserted into cavity 26 as the cavity is formed.

In addition, binding 28 can exhibit elastic properties. Thus upon completion of method 20, binding 28 can secure trim 22 in the selected position and can aid in providing elasticity to blank 10.

Method 20 includes temporarily securing trim 22 in place using one or more temporary seams 30 (only one shown). Seam 30 can aid in securing binding 28 in cavity 26. Seam 30 can also aid in maintaining edge 12 in the selected position with respect to first side 16.

Seam 30, similar to the application of binding 28 discussed above, can be incorporated into blank 10 substantially simultaneous to the folding of the blank. Accordingly, a first step of method 20 provides for the substantially simultaneous folding to form trim 22, application of binding 28, and sewing to form seam 30.

However, seam 30 is a temporary seam. Specifically, seam 30 is formed with a yarn (not shown) that dissipates upon further processing. For example, seam 30 can be a heat labile seam that dissipates upon application of heat. As used in this application, the term “dissipate” means that the seam substantially disappears both visually and tactilely.

In an exemplary embodiment, binding 28 can be a heat-activated adhesive binding that is activated at a first level of heat exposure. During exposure of heat to binding 28, trim 22 is maintained under a selected compression to ensure that binding 28 is firmly secured in cavity 26. Thus, binding 28 bonds first side 16 to itself to maintain peripheral edge 12 in the selected position, which forms curved edge 24 on blank 10.

In this same embodiment, seam 30 can be formed from a heat labile yarn that dissipates at a second level of heat exposure. Advantageously, the second level of heat exposure is less than the first level of heat exposure. Thus, the activation of binding 28 and the dissipation of seam 30 can occur at the same time, namely within the first level of heat exposure that is required to activate the binding. In this manner, method 20 not only provides the seamless trim 22, but can also provide the seamless trim in a minimal amount of time.

For example, binding 28 can be an EB 3106 adhesive commercially available from Bemis. Further, seam 30 can be formed with a Thermolux yarn that is commercially available from Luxilon Industries of Belgium. In this example, binding 28 is activated at a level of heat exposure of about 160 degrees Celsius to about 190 degrees Celsius for about 19 seconds. However, seam 30 dissipates at a level of heat exposure of about 15 seconds at about 140 degrees Celsius.

Thus, method 20 provides a simple, two step operation to form seamless trim 22 on blank 10. During the first step, edges 12 of blank 10 are folded, binding 28 is applied, and temporary seam 30 is sewn. During the second step, binding 28 is activated and seam 30 is dissipated.

In an alternate embodiment, seam 30 is formed from a soluble yarn that dissipates upon exposure to a selected solvent, such as water. Thus, seam 30 dissipates during further common solvent containing processes that blank 10 is exposed to instead of during the activation of binding 28. For example, seam 30 can be dissipated by one or more solvents associated with any conventional dyeing process used to color blank 10.

Seam 30 can instead be dissipated by the steam and/or heat associated with any conventional heat setting process used to shape blank 10. Further, seam 30 can instead be dissipated by water associated with any common washing process used to clean blank 10.

Advantageously, method 20 provides for trim 22 to be of a higher quality control than would be expected if the method did not include seam 30. Namely, seam 30 maintains trim 22 in the selected position until binding 28 has been activated. Thus, blanks 10 can be quickly bulk manufactured with trim 22 in substantially the same location from blank to blank.

Further, method 20 does not slow the manufacture of blank 10 into a garment. It has been determined that seam 30 can be applied and removed within the time frame of one or more of the further processing steps that are common in the manufacture of blank 10.

In this manner, trim 22 can mitigate unraveling of blank 10 at peripheral edge 12 by moving the peripheral edge to the inside of the blank. Further, trim 22 can be used to provide elastic properties to blank 10 and/or provide a decorative or aesthetically pleasing appearance to the blank.

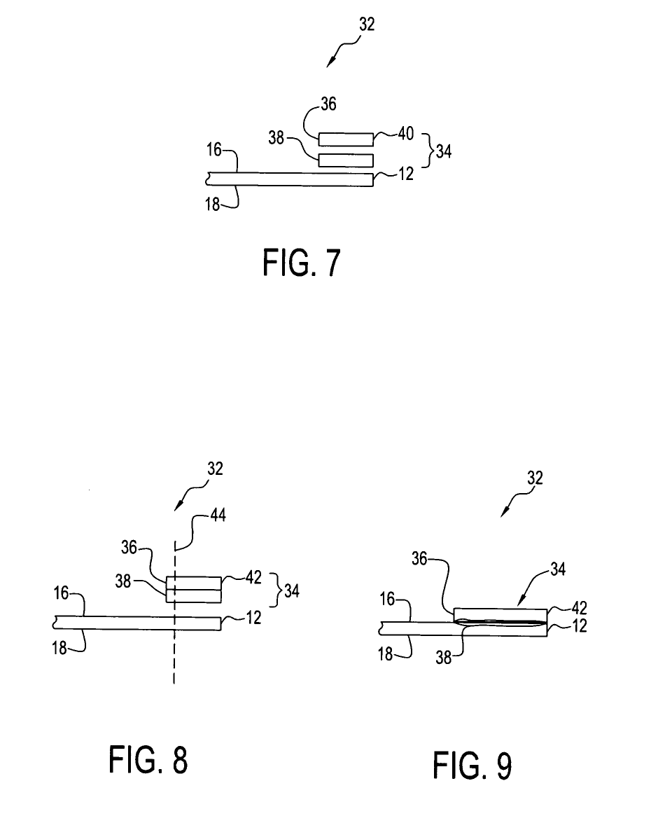

A second exemplary embodiment of a method 32 according to the present invention for providing peripheral edges 12 with a seamless trim 34 is illustrated with simultaneous reference to FIGS. 7 through 9. In this embodiment, trim 34 is a fabric layer glued to first and/or second side 16, 18 of blank 10.

Trim 34 includes a fabric layer 36 and an adhesive layer 38. During method 32, trim 34 is placed in a selected position on blank 10 so that adhesive layer 38 contacts the blank.

In one embodiment of the present invention, fabric layer 36 and adhesive layer 38 are separate layers. Here, method 32 applies fabric and adhesive layers 36, 38 to blank 10 either sequentially or simultaneously. In a preferred embodiment, trim 34 is a unitary member of fabric layer 36 and adhesive layer 38. For example, trim 34 can be a laminated member 40 formed from fabric layer 36 and adhesive layer 38 as shown in FIG. 8. In this embodiment, fabric and adhesive layers 36, 38 are simultaneously applied to blank 10 by method 32. In a preferred embodiment of laminated member 40, fabric layer 36 is a fabric having nylon and elastane fibers, and adhesive layer 38 is a layer of polyurethane adhesive layer.

Preferably, method 32 positions trim 34 on blank 10 so that a peripheral edge 42 of fabric layer 36 is co-planar with peripheral edge 12 of the blank. Namely, it is preferred that peripheral edges 12 and 42 form a linear plane through the edges as shown in FIG. 9.

Next, method 32 temporarily secures trim 34 to blank 10 in the selected position using one or more seams 44 (only one of which is shown). Seam 44 aids in maintaining trim 34 in the selected position with respect to first side 16. For example, seam 44 can maintain peripheral edges 12, 42 in a co-planar relationship. Preferably, trim 34 is simultaneously positioned on blank 10 and seam 44 is applied to the trim.

Fabric layer 36 preferably exhibits elastic properties. In addition, adhesive layer 38 preferably exhibits elastic properties. For example, adhesive layer 38, before fusing, can exhibit recovery of about 98 percent, and a modulus of about 0.13 pounds. Thus, adhesive layer 38 can both secure fabric layer 36 in the selected position on blank 10 and aid fabric layer 36 in providing elasticity to the blank.

Seam 44 is formed with a yarn (not shown) that dissipates upon further processing. For example, seam 44 can be a heat labile seam that dissipates upon application of heat.

In one embodiment, adhesive layer 38 can be a heat-activated adhesive, which is activated upon exposure to a first level of heat. During exposure to the first level of heat, trim 34 is compressed to ensure that fabric layer 36 is firmly secured to blank 10. Thus, adhesive layer 38 bonds fabric layer 36 in the selected position to blank 10. For example, activation of adhesive layer 38 can cause the adhesive layer to melt and penetrate into at least a portion of blank 10 and fabric layer 36 as shown in FIG. 9. It has been found that penetration of adhesive layer 38 into blank 10 at peripheral edge 12 mitigates instances of the blank unraveling at the peripheral edge.

In this same embodiment, seam 44 can be formed from a heat labile yarn that dissipates at a second level of heat exposure. Advantageously, the second level of heat exposure is less than the first level of heat exposure. Thus, the activation of adhesive layer 38 and the dissipation of seam 44 can occur at the same time, namely within the first level of heat exposure that is required to activate the adhesive. In this manner, method 32 not only provides seamless trim 34 in a selected position, but can also provide the seamless trim in a minimal amount of time.

Adhesive layer 38 can be a polyurethane adhesive layer 38 commercially available from Bemis Adhesive Films and Coatings. Further, seam 44 can be formed with a Thermolux yarn that is commercially available from Luxilon Industries of Belgium. In this example, adhesive layer 38 is Bemis part number 3410 (0.001″) that is activated at a first level of heat exposure of about 175° C. degrees Celsius to about 200° C. degrees Celsius for about 20 to about 30 seconds, with a pressure of about 40 to about 60 pounds per square inch. However, seam 44 dissipates at a second level of heat exposure of about 15 seconds at about 140 degrees Celsius. Thus, method 32 provides a simple, two step operation to form seamless trim 34 on blank 10. During the first step, trim 34 is applied to blank 10 and temporary seam 44 is sewn. During the second step, adhesive layer 38 is activated and seam 44 is dissipated.

It has also been determined that the heat and pressure of the second step of method 32 can be used to heat set blank 10 to a desired size and/or shape. In this manner, the second step can simultaneously activate adhesive layer 38, dissipate seam 44, and heat set blank 10. For example, blank 10 can be placed on a mold sized to shape blank 10 to the desired shape. The mold can expand blank 10 to the desired shape and to remove any wrinkles from the blank prior to activation of adhesive layer 38.

In an alternate embodiment, seam 44 is formed from a soluble yarn that dissipates upon exposure to a selected solvent, such as water. Thus, seam 44 dissipates during further common solvent containing processes that blank 10 is exposed to instead of during the activation of adhesive layer 38. For example, seam 44 can be dissipated by one or more solvents associated with any conventional dyeing process used to color blank 10. Alternately, seam 44 can be dissipated by water associated with any common washing process used to clean blank 10. In still other exemplary embodiments, seam 44 can be dissipated by the steam and/or heat associated with any conventional heat setting process used to shape blank 10.

In other embodiments, method 32 can include an edge-trimming step. The edge-trimming step can ensure peripheral edges 12 and 42 form the linear plane shown in FIG. 9. For example, the edge-trimming step can alleviate or correct any deviations between the position of peripheral edges 12 and 42 induced by the activation of adhesive layer 38 or other processes. It is also contemplated for edge-trimming step to define a finished outline shape to peripheral edges 12, 42. The finished outline can be a straight edge, a curved edge, a lace edge, or and other decorative edge shapes.

Advantageously, method 32 provides for trim 34 to be of a higher quality control than would be expected if method 32 did not include seam 44. Namely, seam 44 maintains trim 34 in the selected position on blank 10 until adhesive layer 38 has been activated. Thus, blanks 10 can be quickly bulk manufactured with trim 34 in substantially the same location from blank to blank. Blanks 10 can also be manufactured using standard sewing machines instead of special equipment such as edge banding fusing machines.

Further, method 32 does not slow the manufacture of blank 10 into a garment. It has been determined that seam 44 can be applied and removed within the time frame of one or more of the further processing steps that are common in the manufacture of blank 10.

In the illustrated embodiment, trim 34 is applied in a selected position to first side 16 of blank 10, which faces the skin of the wearer. Thus, trim 34 is not visible from the exterior of blank 10. Of course, it is contemplated by the present invention for first side 16 to face away from the wearer so that trim 34 is applied to the exterior of blank 10. It is also contemplated by the present invention for trim 34 to be applied to both the first and second sides 16, 18, respectively, of blank 10.

Accordingly, method 32 seamlessly secures trim 34 to blank 10. The penetration of adhesive layer 38 in blank 10 at peripheral edge 12 can mitigate unraveling of the peripheral edge. In the embodiments where fabric layer 36 is elastic, method 32 can also seamlessly provide elastic properties to blank 10. In the embodiments where trim 34 is exterior to blank 10, the trim can provide a decorative or aesthetically pleasing appearance to the blank.

It should be recognized that blank 10 is illustrated by way of example as a tubular blank. Such tubular blanks 10 can be formed using circular knitting machines that are commercially available from, for example, Santoni of Italy. Of course, blank 10 can be formed by other methods such as traditional cut-and-sew methods.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that the invention will include all embodiments falling within the scope of the appended claims.

1. A method of forming a garment blank having a seamless trim, comprising:
applying an adhesive layer in a selected position on the garment blank;
applying a fabric layer to said adhesive layer;
securing said adhesive and fabric layers in said selected position with a seam; and
exposing the garment blank to at least one condition sufficient to cause said adhesive layer to bond said fabric layer to the garment blank and said seam to dissipate.

2. The method of claim 1, wherein said adhesive layer and said fabric layer are applied simultaneously or sequentially.

3. The method of claim 2, wherein said adhesive layer and said fabric layer are a laminate.

4. The method of claim 1, wherein said seam is formed of a heat labile yarn.

5. The method of claim 4, wherein said at least one condition is a first heat level sufficient to cause said adhesive layer to bond said fabric layer to the garment blank and said seam to dissipate.

6. The method of claim 1, wherein said seam is formed of a soluble yarn.

7. The method of claim 6, wherein said at least one condition is a first condition and a second condition.

8. The method of claim 7, wherein said first condition is a first heat level sufficient to cause said adhesive layer to bond said fabric layer to the garment blank.

9. The method of claim 7, wherein said second condition is a solvent exposure condition sufficient to cause said seam to dissipate.

10. The method of claim 1, further comprising trimming said adhesive and fabric layers after exposing the garment blank to said at least one condition.

11. A method of forming a garment blank having a seamless trim, comprising:
applying a laminated member to the garment blank so that an adhesive layer of said laminated member contacts the garment blank and a fabric layer of said laminated member has a selected position with respect to the garment blank;
maintaining said laminated member in said selected position with a seam;
activating said adhesive layer with a first level of heat to secure said fabric layer in said selected position; and
applying a second level of heat to said laminated member to cause said seam to dissipate.

12. The method of claim 11, further comprising trimming said adhesive and fabric layers after activating said adhesive layer.

13. The method of claim 11, wherein said fabric layer comprises an elastic fabric.

14. The method of claim 13, wherein said adhesive layer has elastic properties.

15. The method of claim 11, wherein said seam is formed of a heat labile yarn.

16. The method of claim 15, wherein said second level of heat is less than said first level of heat so that said seam dissipates simultaneously with activation of said adhesive layer.

17. The method of claim 11, wherein said fabric layer has a peripheral edge that is co-planar with a peripheral edge of the garment blank.

18. The method of claim 17, wherein said adhesive layer penetrates at least said peripheral edge of the garment blank upon activation.

19. The method of claim 11, wherein said adhesive layer comprises a polyurethane adhesive and said fabric layer comprises nylon and elastane fibers.

20. A method of forming a garment blank having a seamless trim comprising:
applying a laminated member to a first side of the garment blank at a peripheral edge of the garment blank, said laminated member having an adhesive layer and a fabric layer, said adhesive layer being in contact with the garment blank;
sewing said laminated member to the garment blank with at least one seam;
activating said adhesive layer to secure said fabric layer to the garment blank; and
dissipating said at least one seam.

21. The method of claim 20, wherein said adhesive layer is activated simultaneously with the dissipation of said at least one seam.

22. The method of claim 20, wherein dissipating said at least one seam comprises exposing said at least one seam to a selected heat level or a selected solvent.

23. The method of claim 20, wherein applying said laminated member comprises aligning a peripheral edge of said fabric layer with said peripheral edge of the garment blank so that said peripheral edges are co-planar.

24. The method of claim 20, wherein said fabric layer comprises an elastic fabric.

25. The method of claim 20, further comprising heat setting the garment blank to a desired shape and/or size.

26. The method of claim 25, wherein said adhesive layer is activated simultaneously with the dissipation of said at least one seam and said heat setting of the garment blank.
